(19) United States
(12) Patent Application Publication
(10) Pub. No.: US 2011/0117429 A1
(43) Pub. Date: May 19, 2011

(54) GALVANIC CELL WITH IMPROVED LIFETIME

(75) Inventors: Jurgen Hofmann, Kamenz (DE); Magnus Mickel, Wittichenau (DE); Gunter Eichinger, Altenstadt (DE)

(73) Assignee: LI-TEC BATTERY GMBH, Kamenz (DE)

(21) Appl. No.: 12/936,834

(22) PCT Filed: Apr. 3, 2009
(86) PCT No.: PCT/EP09/02487

§ 371 Date: Dec. 23, 2010

(30) Foreign Application Priority Data
Oct. 7, 2010 (DE) 10 2008 018 061.0

(51) Int. Cl. H01M 4/66; H01M 10/26

(52) U.S. Cl. 429/206; 429/245

(57) ABSTRACT

The invention relates to a galvanic cell, which chemically stores energy and supplies electric energy. The galvanic cell comprises at least two electrodes (32, 34) and conductors (31, 35), associated with said electrodes. The cross-sections of the conductors are dimensioned such, that the electric resistance of the conductors and the electric power losses thus created, are approximately equal. The use of such conductors is described with respect to rechargeable galvanic cells, the electrolyte of which comprises lithium ions.

The invention relates to a galvanic cell, which chemically stores energy and which electrically provides energy. The invention will be described in terms of rechargeable galvanic cells, the electrolyte of which comprises lithium ions. It is noted, however, that the invention can also be used with galvanic cells that are intended for single use only, and/or with other electrolytes.

According to the prior art, various types of rechargeable galvanic cells are known. These have in common, that the capacity to store energy decreases with increasing time of operation. The cells age.

The object of the present invention is, therefore, to increase the lifetime of galvanic cells. This is accomplished by the subject-matter of the independent claims of the invention. Advantageous embodiments and further developments are the subject-matter of the dependent claims.

A galvanic cell according to the invention, designed as a primary or secondary cell can deliver an electrical current. The galvanic cell has at least two electrodes. Also, the galvanic cell has at least two conductors, which are each associated with one of the electrodes. Said electric current flows through these conductors. Furthermore, the galvanic cell comprises an electrolyte, which functionally connects said mentioned electrodes. In each conductor, the electric current flows, it generates a power loss. The cross sections of these conductors are of such a size, so that a ratio of these power losses is smaller than a predetermined value.

Although there are different constructions of galvanic cells, each construction however comprises at least one positive electrode, a negative electrode, and an electrolyte, which provides an electrochemical connection between the positive and the negative electrode. A galvanic cell stores energy in chemical form. An electric current can be provided by means of transforming stored chemical energy into electrical energy.

A primary cell (battery) is defined as a galvanic cell, which by means of using up the electrodes delivers electrical current for a certain time. Subsequently, the electrodes must be renewed or the galvanic cell is no longer usable.

A galvanic secondary cell refers to a rechargeable storage device (battery) for storing energy. The galvanic secondary cell is first charged and, subsequently, it can provide said current and be recharged again. The transformation from electrical into chemical energy (and vice versa) is associated with an energy loss. The rechargeable storage unit is aging with increasing number of charge/discharge cycles. Irreversible chemical reactions increasingly change portions of the electrodes and of the electrolyte. These portions are no longer available for the transformation of electrical into chemical energy (and vice versa).

The electrodes are used for the storage of energy in chemical form. At least two electrodes are envisioned. One of these electrodes is mostly charged more negatively (hereinafter referred to as the negative electrode) than the other of these electrodes. Even in the so-called discharged state there is still a remaining voltage between the electrodes and a remaining surplus of electrons in the so-called negative electrode.

A “conductor” refers to an electrical conductor, which is connected in at least an electrically conductive manner with an electrode. A conductor at least electrically connects an electrode with the environment. Moreover, said connection between a conductor and an electrode can enable thermal and/or mechanical processes. This way, the heat energy, which is generated by the power loss in a conductor can be guided into the centre of a galvanic cell via said conductor.

Among others, temperature accelerates chemical processes or partially enable the same in the first place. This applies both to the desired transformation of chemical into electrical energy (and vice versa) and also in regard to unwanted irreversible chemical reactions. In particular the latter contribute to the aging of a galvanic cell. Thus, an undesirable heating of areas of a galvanic cell is to be avoided.

Conductors generally provide resistance towards an electrical current. The amount of resistance depends on the specific material used and can vary significantly over a certain range. For conducting energy in technical processes, usually metallic conductors are used. This applies also for the conductors of the galvanic cell of the invention. Often, the materials of several conductors differ and have different specific conductivities (or specific resistances). If a conductor is exposed to an electric current, said current generates a power loss in said conductor. Said power loss is proportional to the electrical resistance of the material, as well as to the square root of the current, which flows through the conductor. This power loss usually leads to a heating of the electrical conductor. For electrical conductors with different electrical resistances, the same electrical current causes different degrees of power losses and of heat generation. Unless the conductors are exposed to otherwise identical environments, differences in heat generation are the result thereof. Consequently, a conductor with an poor electrical conductive material heats up more.

The electrical resistance of a conductor is generally calculated based on the conductive cross-sectional area, the length of said conductor, and the specific electrical resistance. The cross-sectional area can be enlarged to reduce the heating of a conductor. For similar power losses in said conductors, a larger specific electrical resistance of a conductor can be compensated by a larger cross-sectional area. Power losses can be limited to a certain ratio by using different cross-sectional areas for conductors made of different materials.

The device according to the invention is characterized in operation by reduced temperature differences between the conductors. Also, the operating temperature of a poor electrical conductive conductor—if present—is advantageously reduced, compared to conventional devices. Less thermal energy is transported into the centre of the galvanic cell. A leading cause for the thermally induced aging of the affected materials is thereby reduced. Thus, the lifetime of the galvanic cell is increased and the underlying problem is solved.

To solve the underlying problem, it is advantageous to set the limits of the ratio of the power losses to 40%. Depending on the environmental conditions or the intended use of a single or of a group of galvanic cells, this limit is set to 20%, 10%, 5%, 2%, or 1%, respectively. The ratio of two power losses P1 and P2 is calculated from the difference of said power losses (P1 and P2) divided by the square root of the product of said power losses (P1 and P2):

$$Ratio \text{:} \frac{\vert {P}_{1} - {P}_{2} \vert}{\sqrt{{P}_{1} * {P}_{2}}}$$

Preferably, an electrical conductor of a negative electrode comprises copper and/or nickel. Particularly preferably, said conductor predominantly comprises copper and/or nickel.

Preferably, each conductor for a positive electrode comprises aluminium. Particularly preferably, said conductor predominantly comprises aluminium.

A conductor which is associated with a negative electrode preferably, comprises a core area with a first material. Said core area is preferably at least partially surrounded in the surrounding area by a second material. Said second material is electrically less conductive, respectively, is characterized by a stronger specific electrical resistance than said first material. At the same time, said second material is chemically more stable than said first material with respect to the electrolyte and/or the environment. For the function of a galvanic cell the use of a certain material for a conductor and/or the use of a certain electrolyte can be the preferred choice or particularly economical.

Possibly, the electrolyte employed is chemically damaging for the material of a conductor. In these cases, a conductor can preferably be at least partially covered with a chemically resistant material. Also the environment can be detrimental to the first material of the conductor. A casing can also be used for protecting said first material against environmental influences.

Said conductor can be in contact with the electrolyte and/or the environment within a contact area of a conductor. Advantageously, the surrounding area of said conductor coincides with said contact area, so that a direct contact of the electrolyte and/or the environment with the core area of the conductor is avoided. Particular advantageously, the core area of a conductor which is associated to a negative electrode can also be completely encased. This contributes to the resistance of the core area of the conductor towards the electrolyte and/or the environment.

Preferably, said second material is selected so that it is chemically resistant towards the electrolyte used and/or the environment, even at voltages larger than 3.5 volts within the galvanic cell, respectively, between said electrodes.

Preferably, said first material comprises copper and/or said second material comprises nickel. Particularly preferably, said first material predominantly comprises copper and/or said second material predominantly comprises nickel.

A conductor associated with a positive electrode preferably comprises a core area with a third material and a surrounding area with a fourth material. Thereby, the surrounding area is at least partially surrounding the core area. The fourth material is selected in a way so that it is electrically less conductive than the third material. Also, with respect to the electrolyte, said fourth material is chemically more stable than said third material. For the function of a galvanic cell, the use of a certain material for a conductor and/or the use of a certain electrolyte can be the preferred choice or particularly economical. Possibly, the employed electrolyte is chemically damaging for the material of a conductor. In these cases, a conductor can be, preferably, at least partially covered with a chemically resistant material. Also, the environment can be detrimental to the first material of the conductor. A casing can also be used for protecting said third material against environmental influences.

Preferably, a conductor for a positive electrode comprises a contact area. Said contact area is in contact with the electrolyte and/or the environment. Preferably, the surrounding area of said conductor is limited to said contact area. Particularly preferably, the core area of said conductor is completely surrounded by the surrounding area.

Preferably, said fourth material is selected in that way, as to be chemically resistant with respect to the employed electrolyte and/or the environment, even at voltages larger than 3.5 volts within the galvanic cell, respectively, between said electrodes. Preferably, said third material comprises copper and/or said fourth material comprises aluminum. Particularly preferably, said third material predominantly comprises copper and/or said fourth material predominantly comprises aluminum.

An electrode of the galvanic cell of the invention comprises a conductor contact area. In this area, contact with at least one associated conductor is established. Said conductor contact area is flown through by an electrical current. Said conductor contact area can also be configured as a two-dimensional area. Preferably, said cross-sectional area of said conductor contact area, which is flown through by said electrical current, is at least as large as the cross-section of the associated conductor. This way, a bottleneck in respect to the circuit is avoided.

Preferably, an electrode of a galvanic cell is connected with at least one associated conductor within said conductor contact area of the electrode. Preferably, said connection is achieved by a welded connection, which is designed in a electrically conductive manner in regard to the electric current. Particularly preferably, said welded connection is achieved with an ultrasonic welding process.

The galvanic cell of the invention is suited for the use with different materials and electrolytes. Preferably, the electrolyte comprises at least lithium-ions.

Particularly preferred geometric arrangements of cells, respectively batteries (arrays of cells), are illustrated in the figures, wherein

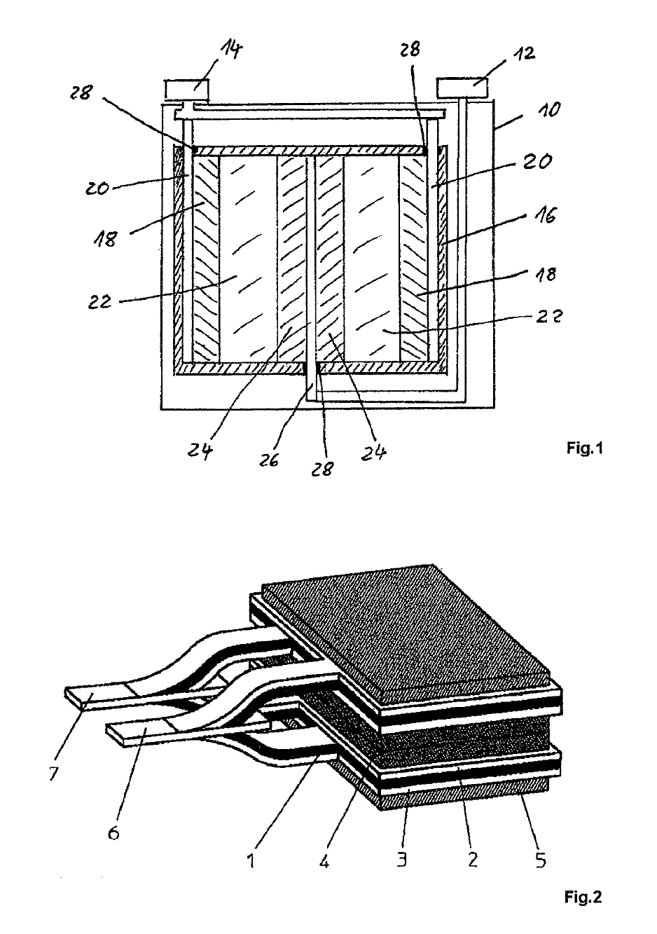

FIG. 1 shows the cross section of a lithium-ion rechargeable battery,

FIG. 2 shows a perspective view of another embodiment of a lithium-ion rechargeable battery, and

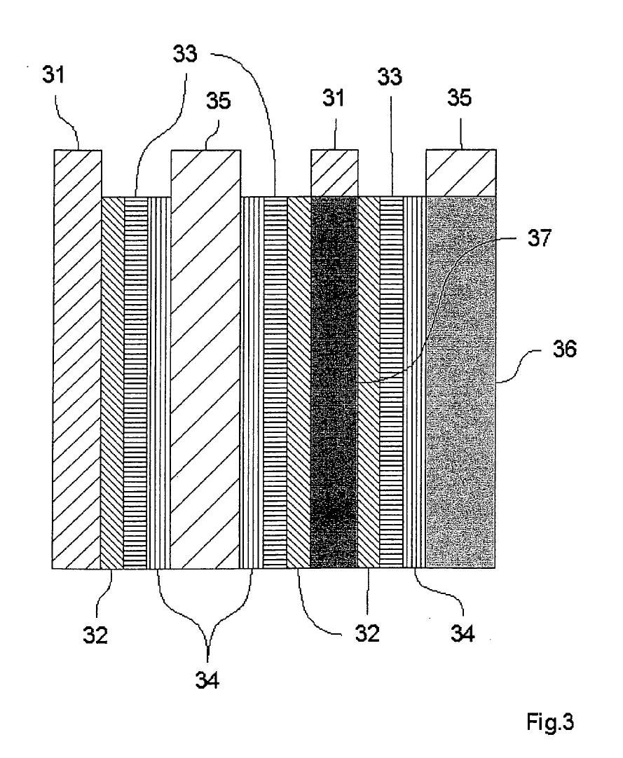

FIG. 3 shows a schematic illustration of the layering of some components of a galvanic cell.

In FIG. 1, a lithium-ion rechargeable battery is enclosed by a housing (10). Between the negative electrode (18) and the positive electrode (24), the electrolyte (22) is situated. The accumulator has two halves, wherein in each half, two electrodes with interposed electrolytes are contained. The two halves are hermetically sealed within the packaging of the galvanic cell (16), which is, for example, made of plastic. The current conductors (20) for the negative electrode (18) are inserted in an airtight manner into the cell through a sealing (28). Similarly, the same applies for the current conductor (26), made of aluminum, which belongs to the positive electrode (24). The current conductors (20) respectively (26) lead to the battery terminals (14) and (12) which are arranged outside the housing.

FIG. 2 shows the construction of a second embodiment. Here, the negative electrode (4) is applied to the collector layer (2), and the positive electrode (5) is applied to the collector layer (3). This electrode assembly can be stacked or wound in any desired number and, subsequently, soaked with an electrolyte and packed. In FIG. 2 two such assemblies are stacked. The external conductor terminals are labelled (6) for the positive electrode, and (7) for the negative electrode.

FIG. 3 shows a schematic arrangement, which can be found in a galvanic cell. The illustration points out the different thicknesses of the conductors to compensate different electrical conductivity. In the illustration, from the left to the right, the following components are depicted by means of squares: a negative current conductor (31), a negative electrode (32), an electrolyte layer (33), a positive electrode (34), and a comparatively thicker positive conductor (35). Said positive conductor (35) is made of a poorer electrically conductive material than the negative conductor (31). Assuming the same depth of the layers, the cross-section of the positive conductor (35) is enlarged, to limit the difference of the power loss according to the invention. FIG. 3 also shows that a conductor (35) can be in an operative connection with multiple electrodes (34). The layer structure continues symmetrically to the right, up to the next negative conductor (31). The illustration shows, for example, how 3 electrodes (34) can be in contact with just 2 conductors (35). This reduces the number of required conductors, which corresponds with a reduction in material costs.

The ratio of the layer thickness of the conductor (31) and (35) corresponds approximately to the condition when combining copper and aluminum for such a conductor. In case, nickel is, for example, used instead of copper, the layer thickness of the conductor (31) and (35) are to be adjusted accordingly.

The two conductors (31) and (35) on the right side, partially comprise surrounding areas (37) and (36) with coatings of second, respectively fourth material, for the protection of the core are towards the electrolyte and/or the environment.

FIG. 3 does not show that a conductor can be connected with an electrode, that is associated with it, or respectively with its metallic collector, by means of a welded connection.

We claim:

1. A primary or secondary galvanic cell to supply an electric current, said primary or secondary galvanic cell comprising:
at least two electrodes,
at least two conductors, which are each associated with one of these electrodes and through which said electric current flows,
wherein said electric current generates a power loss in each conductor,
and an electrolyte for active connection of said electrodes,
and wherein the respective cross-sections of said conductors are each of a size, so that a ratio of two power losses is smaller than 40%, wherein said ratio is calculated as the modulus of the difference of two power losses, divided by the square root of the product of the two power losses.

2. The primary or secondary galvanic cell of claim 1, wherein said predetermined limit in respect to said ratio of two power losses is less than or equal to 20%, wherein said ratio is calculated as the modulus of the difference of two power losses, divided by the square root of the product of the two power losses.

3. The primary or secondary galvanic cell of claim 1 wherein each conductor for a negative electrode comprises copper, nickel, or copper nickel.

4. The primary or secondary galvanic cell of claim 1 wherein each conductor for a negative electrode, comprises predominantly copper, nickel, or copper nickel.

5. The primary or secondary galvanic cell of claim 1 wherein each conductor for a positive electrode comprises aluminium.

6. The primary or secondary galvanic cell of claim 5 wherein each electrical conductor for a positive electrode predominantly comprises aluminium.

7. The primary or secondary galvanic cell of claim 1 wherein a conductor, which is associated with a negative electrode has a core area with a first material and a surrounding area with a second material and this surrounding area at least partially encloses said core area, wherein said second material is less electrically conductive than the first material and with respect to the electrolyte and/or the environment, this second material is chemically more stable than said first material.

8. The primary or secondary galvanic cell of claim 7, wherein said negative conductor comprises a contact area for contact with the electrolyte and/or the environment, wherein said surrounding area of said conductor is limited to said contact area.

9. The primary or secondary galvanic cell of claim 7, wherein the surrounding area of said conductor which is associated with one negative electrode completely surrounds the core area of said conductor.

10. The primary or secondary galvanic cell of claim 7 wherein said second material is chemically stable with respect to the electrolyte and/or the environment even at voltages larger than 3.5 V between the electrodes.

11. The primary or secondary galvanic cell of claim 7 wherein said first material, comprises copper and/or this second material comprises nickel.

12. The primary or secondary galvanic cell of claim 7 wherein said first material predominantly comprises copper and/or this second material predominantly comprises nickel.

13. The primary or secondary galvanic cell of claim 1 wherein a conductor which is associated with a positive electrode comprises a core area with a third material, and a surrounding area with a fourth material, and this surrounding area at least partially surrounds said core area, wherein this fourth material is electrically less conductive than the third material, and said fourth material is chemically more stable with respect to the electrolyte and/or the environment than said third material.

14. The primary or secondary galvanic cell of claim 13, wherein said positive conductor comprises a contact area for the contact with the electrolyte and/or the environment, wherein the surrounding area of said conductor is limited to said contact area.

15. The primary or secondary galvanic cell of claim 13 wherein the surrounding area (36) of said conductor which is associated with a positive electrode surrounds its core area completely surrounded.

16. The primary or secondary galvanic cell of claim 13 wherein said fourth material is chemically stable with respect to the electrolyte and/or the environment even at voltages larger than 3.5 V between the electrodes

17. The primary or secondary galvanic cell of claim 13 wherein said third material comprises copper and/or said fourth material comprises aluminum.

18. The primary or secondary galvanic cell of claim 13 wherein said third material comprises mainly copper and/or said fourth material comprises mainly aluminum.

19. The primary or secondary galvanic cell of claim 1 wherein an electrode comprises a conductor contact area for the contact with at least one associated conductor, wherein the cross-sectional area of said conductor contact area, which is subjected to said electrical current, is at least of the size of the cross-section of the associated conductor.

20. The primary or secondary galvanic cell of claim 1 wherein the connection between an electrode or its metallic collector and at least one conductor associated therewith is formed by a welded connection within said conductor contact area.

21. The primary or secondary galvanic cell of claim 20, wherein said welded connection is generated by an ultrasonic welding process.

22. The primary or secondary galvanic cell of claim 1 wherein at least the electrolyte comprises lithium ions.

23. Galvanic cell according to claim 1, wherein said predetermined limit in respect to said ratio of two power losses is less than or equal to 10%, wherein said ratio is calculated as the modulus of the difference of two power losses, divided by the square root of the product of the two power losses.

24. Galvanic cell according to claim 1, wherein said predetermined limit in respect to said ratio of two power losses is less than or equal to 5%, wherein said ratio is calculated as the modulus of the difference of two power losses, divided by the square root of the product of the two power losses.

25. Galvanic cell according to claim 1, wherein said predetermined limit in respect to said ratio of two power losses is less than or equal to 2%, wherein said ratio is calculated as the modulus of the difference of two power losses, divided by the square root of the product of the two power losses.

26. Galvanic cell according to claim 1, wherein said predetermined limit in respect to said ratio of two power losses is less than or equal to 1%, wherein said ratio is calculated as the modulus of the difference of two power losses, divided by the square root of the product of the two power losses.
